(19) United States
(12) Patent Application Publication
(10) Pub. No.: US 2002/0186994 A1
(43) Pub. Date: Dec. 12, 2002

(54) Ink ribbon cartridge

(75) Inventor: Shingo Ito, Tajimi-shi (JP)

Correspondence Address: OLIFF & BERRIDGE, PLC, P.O. Box 19928, Alexandria, VA, 22320, US

(73) Assignee: Brother Kogyo Kabushiki Kaisha

(21) Appl. No.: 10/213,103

(22) Filed: Aug. 7, 2002

Related U.S. Application Data
(63) Continuation of application No. 09/519,474, filed on Mar. 6, 2000.
Application No. 09/519,474 is a division of application No. 09/225,482, filed on Jan. 6, 1999, now Pat. No. 6,257,780.

(30) Foreign Application Priority Data
Jan. 29, 1998 (JP) HEI-10-017042
Jan. 6, 1998 (JP) HEI-10-000869

(51) Int. Cl. B41J 35/28

(52) U.S. Cl. 400/207

(57) ABSTRACT

An ink ribbon is formed form a belt shaped sheet body, and is wound around a pair of tubes. Spools are detachably mounted at each end of the tube bodies. An ink ribbon cartridge includes side plates formed with supporting openings for supporting corresponding spools. Each supporting opening is formed with a cutout portion defined by edges. When the ink ribbon cartridge is mounted in a facsimile machine, the spools are freely rotatable within the supporting openings. On the other hand, when the ink ribbon cartridge is dismounted from the facsimile machine, engagement protrusions formed to the spools catch on the edges defining the cutout portions, thereby preventing the spools form rotating. As a result, the ink ribbon will not unintentionally greatly loosen.

### BACKGROUND OF THE INVENTION

1. Field of the Invention

The present invention relates to an ink ribbon cartridge for use in a recording device, and more specifically to an ink ribbon cartridge including an exchangeable ink ribbon having a broad width.

2. Description of the Related Art

When printing is performed for forming an image on a plain paper using a thermal printer, normally an ink ribbon cartridge is used because it is easy to exchange and simple to handle. Usually, an ink ribbon cartridge includes a broad-width ink ribbon when the thermal printer is a thermal line printer.

In such an ink ribbon cartridge, the ink ribbon is wound around a supply tube and extends to a takeup tube. An ink layer is formed on one surface of the ink ribbon. A spool without a gear is provided at one end of each of the supply tube and the takeup tube, and a spool with a gear is provided at other end of each of the supply tube and the takeup tube. All the spools are provided with a flange. The supply tube and the takeup tube are rotated in their circumferential direction by driving force transmitted via the gears.

When an ink ribbon cartridge is removed from the printer or placed by itself on a table top, for example, or when an operator picks up the ink ribbon cartridge and moves it around, the ink ribbon can undesirably loosen because the spools become freely rotatable with respect to the cartridge case.

Japanese Patent-Application Publication (Kokai) No. HEI-8-276630 discloses configuration for overcoming this problem. Specifically, a pair of tubular spools on which an ink ribbon is wound are rotatably supported in a cartridge case. A compression coil spring is interposed between one end of each spool and first side wall of the cartridge case. The other end of each spool is formed with a groove engageable with an protrusion formed in an opposite second side wall of the cartridge case. The configuration is provided for moving the spools toward the first side wall so the protrusions and grooves fall out of engagement when the ink ribbon cartridge is mounting in a printer.

On the other hand, when the ink ribbon cartridge is removed from the printer, force of the compression coil spring moves the spools in their axial directions, and the protrusions engage with the grooves, thereby preventing the spools from rotating. In this way, the ink ribbon is prevented from loosening.

Also, Japanese Utility-Model-application Publication (Kokai) No. HEI-6-81749 discloses another type of ink ribbon cartridge. A pair of spools on which an ink ribbon is wound are freely rotatably supported in internal of a cartridge case. A compression coil spring is interposed between one end of each spool and a first side wall of the cartridge case. A flange with a large diameter is provided to the other end of the each spool. A friction plate is adhered either an outer surface of each of the flanges an opposite second side wall of the cartridge case confronting the outer surface of each flange.

With this configuration also, when the ink ribbon cartridge is removed from a printer, force of the compression coil springs move the spools in their axial directions, so that the outer surface of each flange is brought into pressing contact with the second side wall of the cartridge case, thereby preventing the spools from undesirably rotating. Therefore, the ink ribbon will not loosen.

However, with this configuration, operations for exchanging the ink ribbon are troublesome. That is to say, when the spools with a spent ink ribbon are removed from the cartridge case, there is a danger that the compression coil springs will fall off the cartridge case. Even if the compression coil springs do not separate from the cartridge case, in order to remove the spools from the cartridge, the compression coil springs need to be once greatly compressed. Further, when mounting the spools with an unused ink ribbon into the cartridge case, the spools cannot be mounted in the compression coil springs unless the compression coil springs are once greatly compressed. For these and other reasons, the existence of the compression coil springs makes operations for exchanging the ink ribbon troublesome.

When the spools are replaced each time a spent ink ribbon is replaced, this wastes resources and increases the costs. Therefore, the spools are removed from the supply tube and the takeup tube with the spent ink ribbon, and mounted onto new supply tube and takeup tube with a fresh ink ribbon, and then mounted back into the cartridge case. At this time, the geared spools must be set at correct ends of the supply tube and the takeup tube and at correct locations in the cartridge case, otherwise the ink ribbon will not be arranged in a correct orientation in the cartridge case.

### SUMMARY OF THE INVENTION

It is conceivable to form one of the spools in a different shape than the other three spools and form one end of the tube bodies so that it will fit only the odd shaped spool. In addition, it is conceivable to form one of the spool flanges with a diameter greater than the other three spool flanges so that the odd shaped spool flange can only fit into a certain supporting hole formed to the cartridge case. With this conceivable configuration, the ink ribbon will not be mounted erroneously in the cartridge case.

However, even with this conceivable configurations, each time an ink ribbon is exchanged, an operator must check to find the spool with the large diameter and then find the corresponding mounting location in the cartridge case. Alternatively, the user may just keep trying to mount the ink ribbon in the cartridge case until he hits on the right flange and mounting location combination. This is troublesome and time consuming.

It is an objective of the present invention to overcome the above-described problems and to provide a simple configuration of an ink ribbon cartridge wherein an ink ribbon can be prevented from undesirably loosening.

It is an another objective of the present invention to provide a simple configuration of an ink ribbon cartridge wherein operations for ink ribbon replacement can be performed quickly and accurately.

In order to achieve the above and other objective, there is provided an ink ribbon cartridge including a case, a first spool, a second spool, a third spool, a fourth spool, a first tube, a second tube, and an ink ribbon. The case has first and plates facing each other. The first plate is formed with first and second openings each with a cutout portion. The second plate is formed with third and fourth openings. The first and the second spools are detachably rotatably mounted in the first and second openings, respectively. The third and fourth spools have a gear and detachably rotatably mounted in the third and fourth openings, respectively. The first tube has a first end and a second end opposite from the first end. The first and second ends are detachably engaged with the first and the second spools, respectively. The second tube has a third end and a fourth end opposite from the third end. The third and fourth ends are detachably engaged with the second and fourth spools, respectively. The ink ribbon is wound around the first tube and the second tube.

There is also provided an ink ribbon cartridge including a case, two pairs of aright spool and a left spool each having a supporting shaft. The case has two pairs of a right side plate and a left side plate each formed with an opening with a cutout portion defined by edges. The right and left spools are detachably rotatably mounted in corresponding openings. The supporting shaft of either one of the right and left spools has a peripheral surface formed with at least one protrusion for catching on the edges defining the cutout portion.

### BRIEF DESCRIPTION OF THE DRAWINGS

The particular features and advantages of the invention as well as other objects will become more apparent from the following description taken in connection with the accompanying drawings, in which:

FIG. 1 is a cross-sectional view of a facsimile machine including an ink ribbon cartridge according to a first embodiment of the present invention;

FIG. 2 is a plan view of the ink ribbon cartridge according to the first embodiment of the present invention;

FIG. 3 is a partial perspective view of the ink ribbon cartridge of FIG. 2 with a portion removed to facilitate explanation;

FIG. 4 is a side view in partial cross-section of a spool of the ribbon cartridge of FIG. 2;

FIG. 5 is a side view in partial cross-section of another spool of the ink ribbon cartridge of FIG. 2;

FIG. 6 is a side view in partial cross-section of still another spool of the ink ribbon cartridge of FIG. 2;

FIG. 7 is a perspective view of the spools shown in FIGS. 5 and 6;

FIG. 8(a) is a right side view of the ink ribbon cartridge;

FIG. 8(b) is a left side view of the ink ribbon cartridge;

FIG. 9(a) is a partial right side view of the ink ribbon cartridge in a lifted up condition;

FIG. 9(b) is an enlarged side view of a protruding rib formed in the spools;

FIG. 10(a) is a side view showing a support opening and a support portion of an ink ribbon cartridge according to a second embodiment of the present invention;

FIG. 10(b) is a side view showing the support opening and the support portion of FIG. 10(a);

FIG. 11 is a plan view of an ink ribbon cartridge as viewed from the above according to the second embodiment of the present invention;

FIG. 12 is a plan view of the ink ribbon cartridge of FIG. 11 as viewed from below;

FIG. 13(a) is a right side view of an ink ribbon cartridge of FIG. 11;

FIG. 13(b) is a left side view of the ink ribbon cartridge shown in FIG. 11;

FIG. 14(a) is a side view of one spool of the ink ribbon cartridge shown in FIG. 11;

FIG. 14(b) is a plan view of the spool of FIG. 14(a);

FIG. 15(a) is a plan view of a portion of another spool of the ink ribbon cartridge shown in FIG. 11;

FIG. 15(b) is an another plan view of the portion of the spool shown in FIG. 15(a);

FIG. 16(a) is a plan view of another portion of the another spool of FIG. 15(a);

FIG. 16(b) is an another plan view of the spool shown in FIG. 16(a);

FIG. 17 is a plan view of still another spool of the ink ribbon cartridge shown in FIG. 11;

FIG. 18 is a cross-sectional view showing the spool of FIG. 17 attached to a cartridge case of the ink ribbon cartridge; and

FIG. 19 is side view showing operations for mounting an ink ribbon into the cartridge case of the ink ribbon cartridge according to a third embodiment of the present invention.

### DETAILED DESCRIPTION OF THE PREFERRED EMBODIMENTS

An ink ribbon cartridge according to preferred embodiments of the present invention will be described while referring to the accompanying drawings. In the following description, the expressions “front”, “rear”, “left”, “right”, “upper”, and “below” are used throughout the description to define the various parts when the printer is disposed in an orientation in which it is intended to be used.

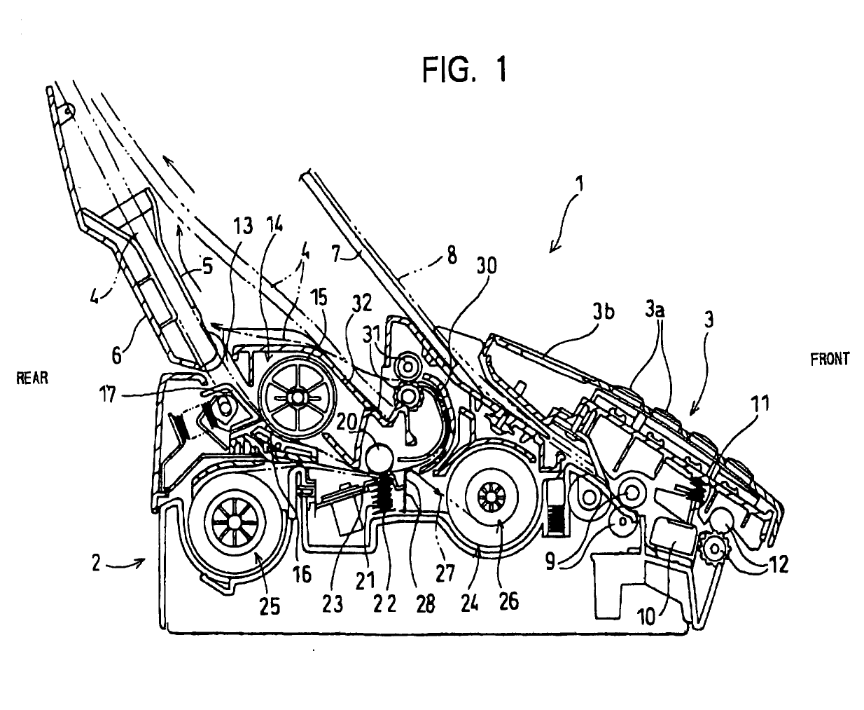

First, a general configuration of a facsimile machine 1 in which an ink ribbon cartridge of the present invention is used will be described while referring to FIG. 1. It should be noted that the facsimile machine 1 shown in FIG. 1 functions both as a facsimile machine and as a printer. Specifically, the facsimile machine 1 retrieves images from a document 8, and transmits image data to another facsimile machine over a telephone circuit. The facsimile machine 1 also receives image data from remote facsimile machines and forms images on recording sheets 4 accordingly. Further, the facsimile machine 1 receives print data transmitted from a word processor or a personal computer over a printer cable or some wireless configuration, such as infrared ray transmission system, and forms an image on the recording sheet 4 based on the print data.

As shown in FIG. 1, the facsimile machine 1 includes a main case 2, an operation panel 3, a pair of sheet guides 5, a cover 6, and a document tray 7. The operation panel 3 is provided at the upper forward portion of the main case 2 and includes key switches 3a and liquid crystal display 3b. The cover 6 is pivotably disposed at the rear of the main case 2 and is for covering the upper side portion of the main case 2 when closed. The pair of the sheet guides 5 are provided to an inner surface of the cover 6 and are for supporting a stack of recording sheets 4 in a slanting upright posture. The document tray 7 is detachably mounted to the upper surface of the main body 2 at a central position between the front and rear of the main case 2 and supports a document 8.

The facsimile machine 1 also includes, a pair of feed rollers 9, a contact image scanner (CIS) 10, a document pressing body 11, a pair of discharge rollers 12, and a sheet supply unit 14. The feed rollers 9 are provided internally to the main body 2 beneath the operation panel 3 and are feeding the document 8 from the document tray 7 in a document feed direction. The CIS 10 is disposed downstream side of the feed rollers 9 in the document feed direction and is retrieving images formed on the document 8. The discharge rollers 12 are rotatably disposed for discharging the document 8 out from the main body 2.

The sheet supply unit 14 is provided beneath the sheet guides 5 and includes a sheet supply roller 15, a separation pad 16, and a pressing member 17. The sheet supply roller 15 feeds, from a sheet supply port 13, one recording sheet 4 at a time in a sheet feed direction. The separation pad 16 is disposed below the sheet supply roller 15 and urges the sheet supply roller 15 using a spring (not shown). The pressing member 17 presses the recording sheets 4 stacked on the cover 6 against the sheet supply roller 15 from a position upstream from the separation pad 16 in the sheet feeding direction.

Further, the facsimile machine 1 includes a recording portion disposed below the sheet feed roller 15. The recording portion includes a roller-shaped platen 20, a spring 21, a thermal head 22, a print mount 23, and an ink ribbon cartridge 24. The thermal head 22 is disposed below the platen 20 and urged by the spring 21 toward the platen 20. The thermal head 22 has a plurality of thermal elements for generating heat when energized. The ink ribbon cartridge 24 is disposed over the print mount 23.

The ink ribbon cartridge 24 includes a supply spool 25, a takeup spool 26, and an ink ribbon 27. The supply spool 25 is disposed at a rear portion of the ink ribbon cartridge 21 and the takeup spool 26 is disposed in front of the supply spool 25. The ink ribbon 27 is wound around the supply spool 25 and the takeup spool 26, and has one ink surface on which an ink layer is formed. A portion of the ink ribbon 27 extends from the supply spool 25 to the takeup spool 26, passing above the upper surface of the thermal head 22 and a plate spring tension body 28, with the ink layer facing upward.

A recording sheet 4 is fed from the sheet guide 5 to a position between the platen 20 and the thermal head 22 while confrontation with the ink layer of the ink ribbon 27. An image is formed one line at a time on the recording sheet 4 by energizing the thermal elements of the thermal head 22 according to image data. Afterwards, the recording sheet 4 is discharged onto a discharge portion 32 provided at the upper surface of the sheet supply portion 14 by the sheet discharge pad 30 and a pair of sheet discharge rollers 31.

Although not shown in the drawings, a handset is disposed at one side of the main body 2 of the facsimile machine 1.

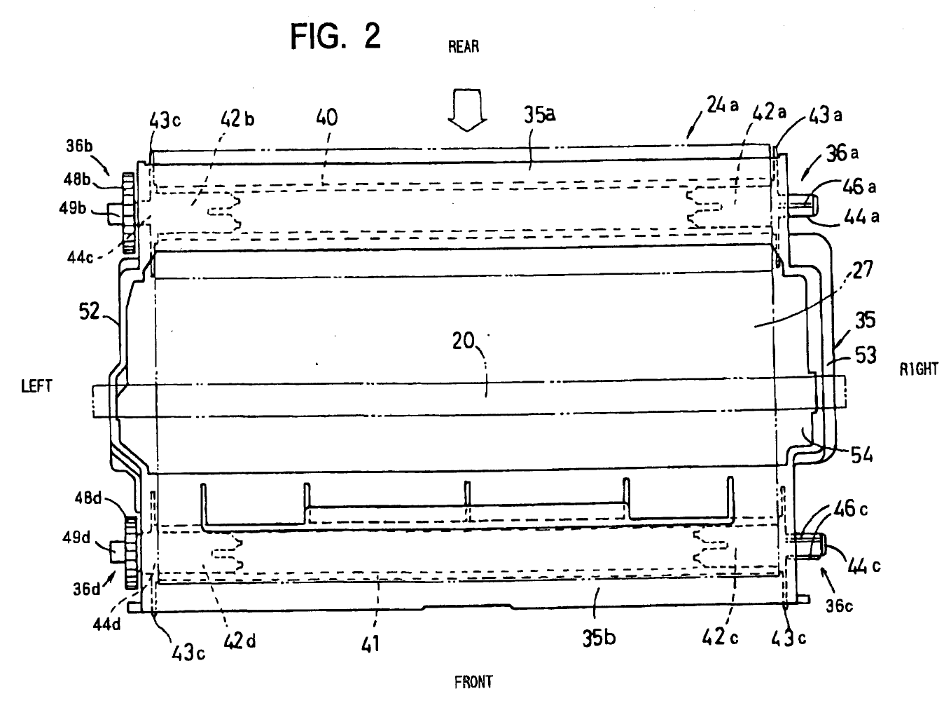

Next, a configuration of an ink ribbon cartridge 24 according to the first embodiment of the present invention will be described while referring to FIGS. 2 to 8(b).

As shown in FIG. 2, the ink ribbon cartridge 24 includes a cartridge case 35, the ink ribbon 27, a pair of right and left supply spools 36a, 36b, a pair of right and left takeup spools 36c, 36d, a cylindrical supply tube 40, and a cylindrical takeup tube 41. Each of the supply tube 40 and the takeup tube 41 has right and left ends. The supply spools 36a, 36b are fitted into the right and left ends of the supply tube 40, respectively, and the takeup spools 36c, 36d are fitted into the right and left ends of the takeup tube 41, respectively. It should be noted that the supply spools 36a. 36b serve as the supply spool 25 shown in FIG. 1, and the takeup spools 36c. 36d serve as the takeup spool 26 shown in FIG. 1. Each of the supply spools 36a, 36b and the takeup spools 36c, 36d (hereinafter collectively referred to as “spools 36”) is integrally formed by, for example, compound resin injection molding.

The ink ribbon 27 is formed from a broad-width resin film and has the ink surface on which the ink layer is formed. As shown in FIG. 2, the ink ribbon 27 is wound around the supply tube 40 and the takeup tube 41, which are made from paper.

Next, configuration of the spools 36 will be described.

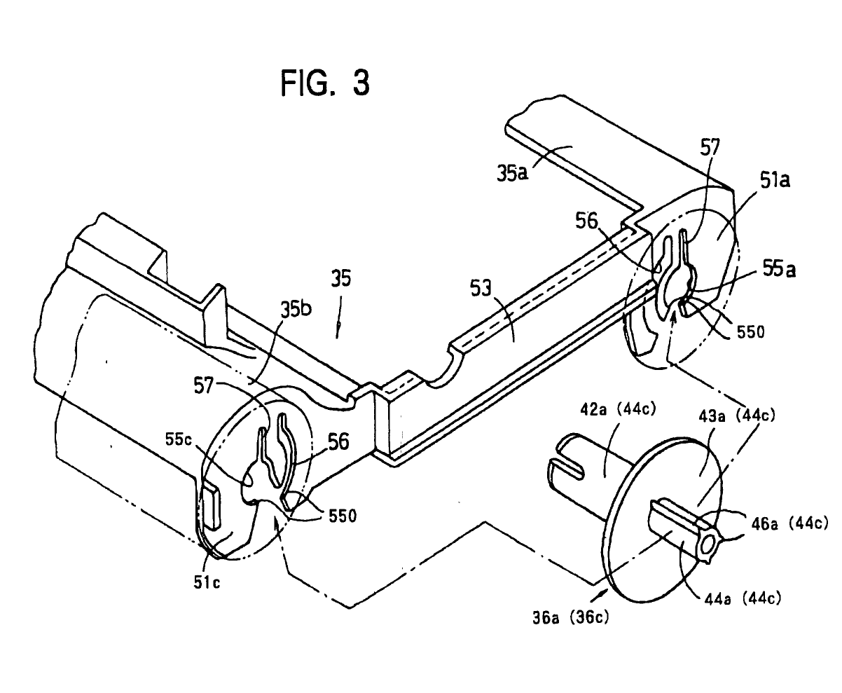

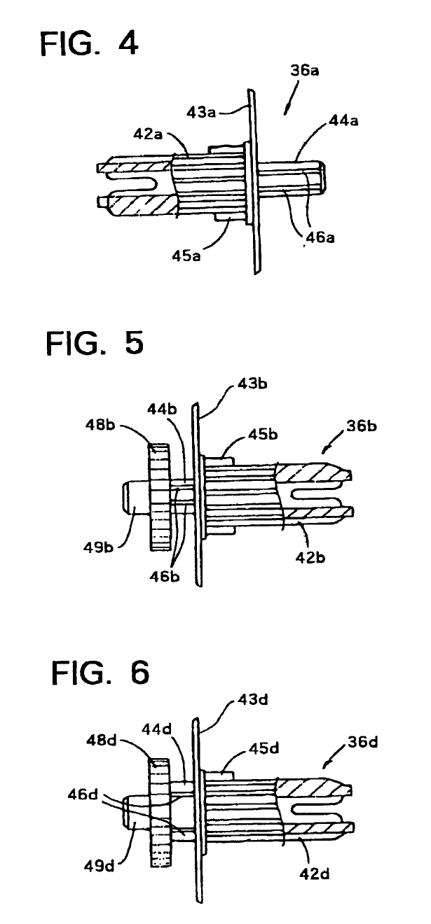

First, the supply spool 36a will be described. It should be noted that the supply spool 36a and the takeup spool 36c have the same configuration, a description for the takeup spool 36c will be omitted. As shown in FIGS. 3 and 4, the supply spool 36a has a cylindrical inner shaft 42a, a flange 43a, and a cylindrical supporting shaft 44a. The flange 43a has a diameter greater than a diameter of the supporting shaft 44a. The inner shaft 42a is detachably fitted in the right end of the supply tube 40, and is formed with engagement protrusions 45a adjacent to the flange 43a. The engagement protrusions 45a are for fitting in engagement grooves (not shown) formed to the supply tube 40 so that the inner shaft 42a will not rotate with respect to the supply tube 40.

The supporting shaft 44a is formed with a plurality of protruding ribs 46a at its outer peripheral surface. The protruding ribs 46a are separated by an appropriate distance from one another in a circumferential direction of the supporting shaft 44a. The protruding ribs 46a are provided for preventing the shaft 36a from idly rotating around the axis of the supporting shaft 44a.

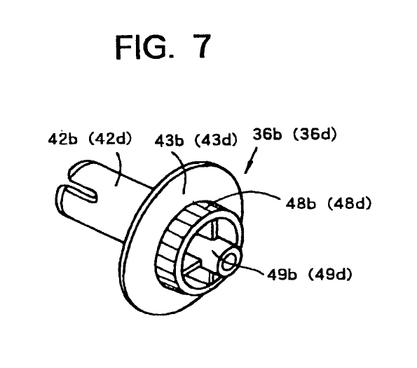

Next, the supply spool 36b will be described. As shown in FIGS. 5 and 7, the supply spool 36b has a cylindrical inner shaft 42b for fitting in the left end of the supply tube body 40, a flange 43b, a cylindrical supporting shaft 44b, a gear 48b, a supporting shaft 44b, and an outer shaft 49b. The flange 43b has a diameter greater than the diameter of the supporting shaft 44b. The gear 48b is provided outside of the flange 43b.

The inner shaft 42b is formed with engagement protrusions 45b adjacent to the flange 43b. The engagement protrusions 45b are provided in a predetermined arrangement for fitting into grooves (not shown) formed to the left end of the supply tube 40. A plurality of protruding ribs 46b are formed to an outer peripheral surface of the supporting shaft 44b so as to be separated by an appropriate distance in the circumferential direction of the supporting shaft 44b. It should be noted that the configuration and the dimensions of the inner shaft 42b and the flange 43b are the same as those of the inner shaft 42a and the flange 43a of the supply spool 36a.

Next, the takeup spool 36d will be described. As shown in FIGS. 6 and 7, the takeup spool 36d has a configuration and dimensions similar to those of the supply spool 36b. However, as shown in FIG. 6, a supporting shaft 44d has a diameter greater than a diameter of the supporting shaft 44b of the supply spool 36b. Also, although not shown in the drawings, engagement protrusions 45d formed to the inner shaft 42d have an arrangement different from that of the engagement protrusions 45b. That is, because the engagement protrusions 45a, 45b, 45c are formed in the same arrangement, the engagement protrusions 45d are formed in the arrangement different from that of all the engagement protrusions 45a, 45b, 45c.

As described above, each end of the supply tube 40 and the takeup tube 41 is formed with the grooves (not shown) for engaging with the engagement protrusions 45 of the corresponding spool 36. Grooves are formed at the left end to the takeup tube 41 with an arrangement that different from the arrangement of the grooves at the right and left ends of the supply tube 40 and at the right end of the takeup tube 41.

With these configuration, the takeup spool 36d can be engaged with the left end of the takeup tube 41. In this way, the position where the takeup spool 36d is mounted is restricted.

Next, an explanation for configuration of the cartridge case 35 will be provided while referring to FIGS. 2, 3. The cartridge case 35 includes a supply-side upper cover 35a, a takeup-side upper cover 35b, a pair of connection ribs 52, 53, and side plates 51a, 51b, 51c, 51d (hereinafter referred to collectively as “side plates 51”). All of these components are integrally formed by, for example, compound resin injection molding. The supply-side upper cover 35a and the takeup-side upper cover 35b are elongated in the left and right directions. The connection rib 52 connects the left end of the supply-side upper cover 35a to the left end of the takeup-side upper cover 35b. Similarly, the connection rib 53 connects the right end of the supply-side upper cover 35a to the right end of the takeup-side upper cover 35b. As a result, the connection ribs 52, 53, the supply-side upper cover 35a, and the takeup-side upper cover 35d define a window portion 54. When the ink ribbon cartridge 24 is mounted to the facsimile machine 1, a portion of the ink ribbon 27 extending between the supply tube 40 and the takeup tube 41 is exposed through the window portion 54 to the platen 20 above and the thermal head 22, the tension body 28, and the print mount 23 below.

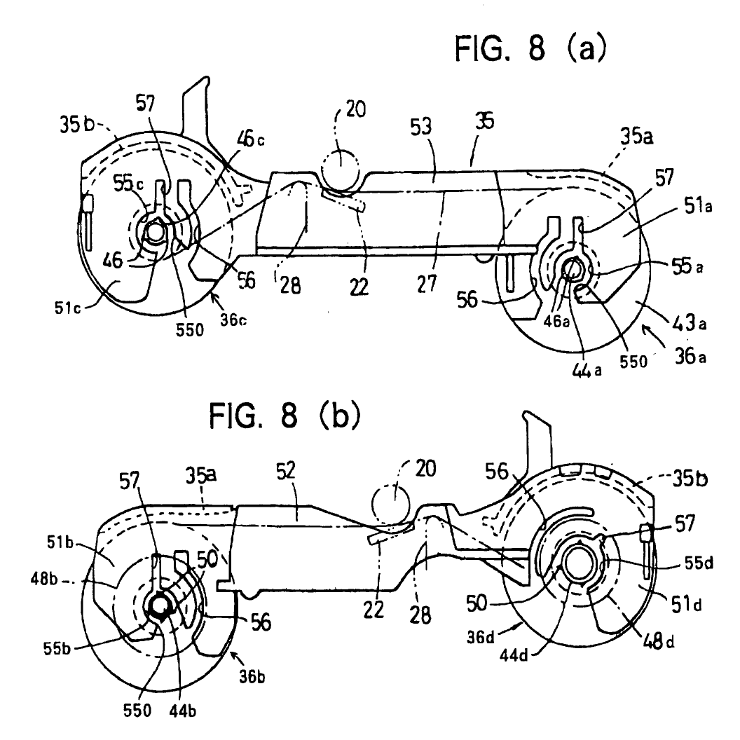

As shown in FIGS. 3, 8(a), 8(b), the side plates 51 are desposed where the connection ribs 52, 53 connect to the supply-side upper cover 35a and the takeup-side upper cover 35b. The side plates 51 are formed with support openings 55a, 55b, 55c, 55d (hereinafter referred to as “support openings 55”), respectively. The supporting shaft 44a to 44d are freely rotatably mounted into corresponding ones of the support openings 55. Each of the support openings 55 is formed with a downward opening cutout portion defined by edges 550, and is also formed with a resilient grooves 56, 57. The resilient grooves 56 are formed external to the openings 55 in a curved shape that substantially follows the contour of the support openings 55. The resilient grooves 57 extend radially from the support openings 55. The support opening 55d has a diameter greater than diameter of the other support openings 55a, 55b, 55c.

In order to mount spools 36, mounted with the ink ribbon 27, into the cartridge case 35, the supporting shafts 44 of the spools 36 are pressed upward into the corresponding support openings 55. At this time, the edges 550 of the support openings 55 resiliently bend to allow the supporting shafts 44 through the downward facing cutout portions into the support openings 55. However, the supporting shafts 44 will not fall out from the support openings 55 once inserted because the width dimension of the cutout portions are smaller than the diameter of corresponding supporting shafts 44. It should be noted that the large diameter supporting portion 44d of the takeup spool 36d can only fit in the large support opening 55d of the side plate 51d. Therefore, the position where the takeup spool 36d is attached to the cartridge case 35 is restricted to the large support opening 55d.

When the ink ribbon cartridge 24 is mounted in the facsimile machine 1, the pair of the connection ribs 52, 53 of the cartridge case 35 are supported in a predetermined posture. At this time, the outer shafts 49b, 49d of the takeup spool 36b and the takeup spool 36d are engaged with protrusions formed on a main frame (not shown) of the facsimile machine 1. Also, the gears 48b, 48d are brought into meshing engagement with drive force transmission gears (not shown). Further, the supporting shafts 44a, 44c of the supply spool 36a and the takeup spool 36c are engaged in protrusions the resiliently protrude from the main frame (not shown).

As a result, as shown in FIG. 8(a), the supporting shafts 44a, 44c of the spools 36a, 36c are arranged in substantial concentric condition with the support openings 55a, 55c of the side plates 51a, 51c. At this time, all of the protruding ribs 46a, 46c on the supporting shafts 44a, 44c are arranged so as not to contact the inner peripheral surface defining the support openings 55a, 55c. Also, as shown in FIG. 8(b), the supporting shafts 44b, 44d of the spools 36b, 36d are arranged in substantial concentric condition with the support openings 55b, 55d of the side plates 51b, 51d. All of the protruding ribs 46b, 46d formed on the supporting shafts 44b, 44d are arranged so as not to contact the inner peripheral surface defining the support openings 55b, 55d. Therefore, the ribbon supply spool 25 and the ribbon takeup spool 26 can smoothly rotate.

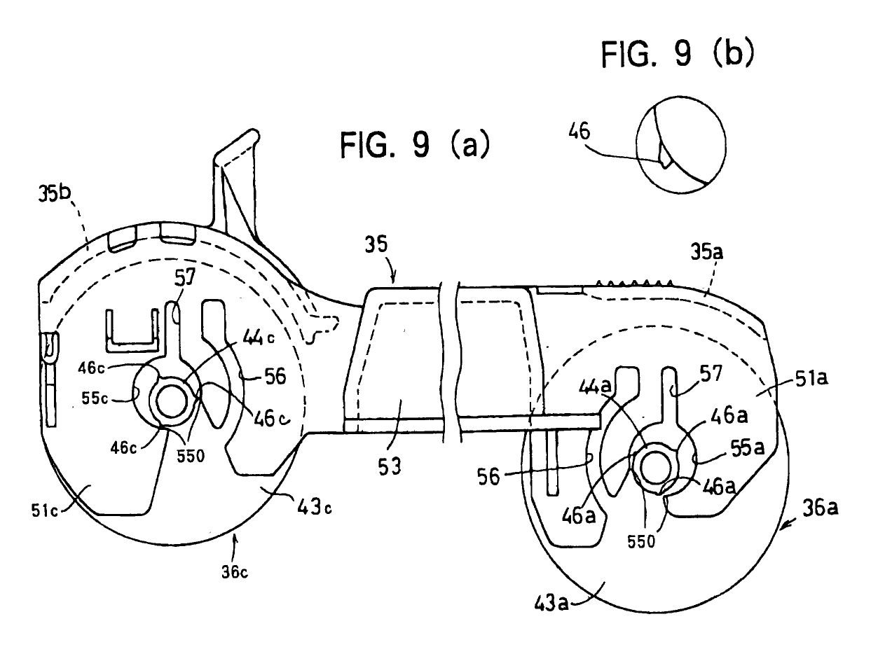

On the other hand, when the operator lifts up the cartridge case 35 when replacing the ink ribbon 27, then as shown in FIG. 9(a), the weight of the ink ribbon 27 and the like shifts the supporting shafts 44 down with respect to the cartridge case 35 into contact with the edges 550 of the support shaft openings 55. As a result, the protruding ribs 46 of the supporting shafts 44 catch on the edges 550, so that the spools 36, that is, the supply tube 40 and the takeup tube 41, are prevented from unintentionally rotating, and the ink ribbon 27 wound around the supply tube 40 and the takeup tube 41 is prevented from loosening.

Also, although not shown in the drawings, when the ink ribbon cartridge 24 is placed on a table (not shown), for example, with the supply-side upper cover 35a and the takeup-side upper cover 35b facing upward, the weight of the cartridge case 35 shifts the support openings 55 down with respect to the supporting shafts 44. As a result, the protruding ribs 46 of the supporting shafts 44 catch on the edges of the grooves 57, so that the spools 36 do not unintentionally rotate, and the ink ribbon 27 is prevented from loosening. It should be noted that even when the ink ribbon cartridge 24 is placed on the table upside down, the spools 36 are prevented from rotating in the same manner as when the ink ribbon cartridge 24 is lifted up. FIG. 9(b) shows an example of the protruding ribs 46.

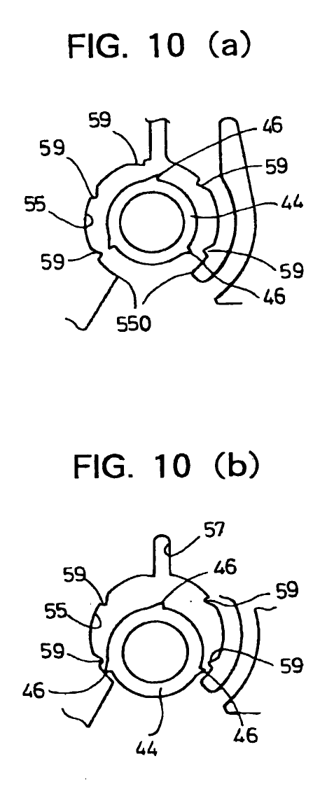

Next, an ink ribbon cartridge according to a second embodiment of the present invention will be described while to FIGS. 10(a), 10(b). The ink ribbon cartridge according to the second embodiment is similar to the ink ribbon cartridge 24 of the first embodiment, except that, as shown in FIGS. 10(a) and 10(b), one or a plurality of supplementary protrusions 59 are formed in an appropriate spacing on an inner peripheral surface defining the supporting openings 55. With this configuration, as shown in FIG. 10(a), when the ink ribbon cartridge is mounted in the facsimile machine 1, the supporting shafts 44 are arranged in concentric condition with the surface defining the support openings 55 in the same manner as in the first embodiment, and the protruding ribs 46 are arranged so as not to contact with the inner peripheral surface.

However, as shown in FIG. 10(b), when the ink ribbon cartridge is lifted up into the air or placed on a table, for example, the supporting shafts 44 shift into an eccentric condition with respect to the support openings 55 so that some of the protruding ribs 46 catch on the supplementary protrusions 59. In this way, the ink ribbon 27 is prevented from loosening.

In the above described first and second embodiments, the protruding ribs 46 are provided to all of the spools 36. However, the same operations and effects of the above-described embodiments can be achieved by providing protruding ribs 46 to only the supply or the takeup spools or to only left or right side spools. In these cases, the supplemental protrusions 59 can be provided to the corresponding support openings 55 if desired.

Also, according to the embodiments described above, when a spent ink ribbon replaced, the spools are removed from the tubes and attached to new ones. Therefore, the configuration is extremely economical.

Further, each spool can be fitted in and removed from a cartridge case of the ink ribbon cartridge by mounting and dismounting the spools into and from supporting openings through the cutout portions. Because there is no need to provide compression coil springs, the configuration of the ink ribbon cartridge is simplified, and operations for mounting and dismounting the spools are also simplified.

Also, by simply providing protrusion ribs around supporting portions of the spools, the spools can be prevented from rotating when the ink ribbon cartridge is taken out from the facsimile machine. Therefore, production costs of the ink ribbon cartridge can be reduced.

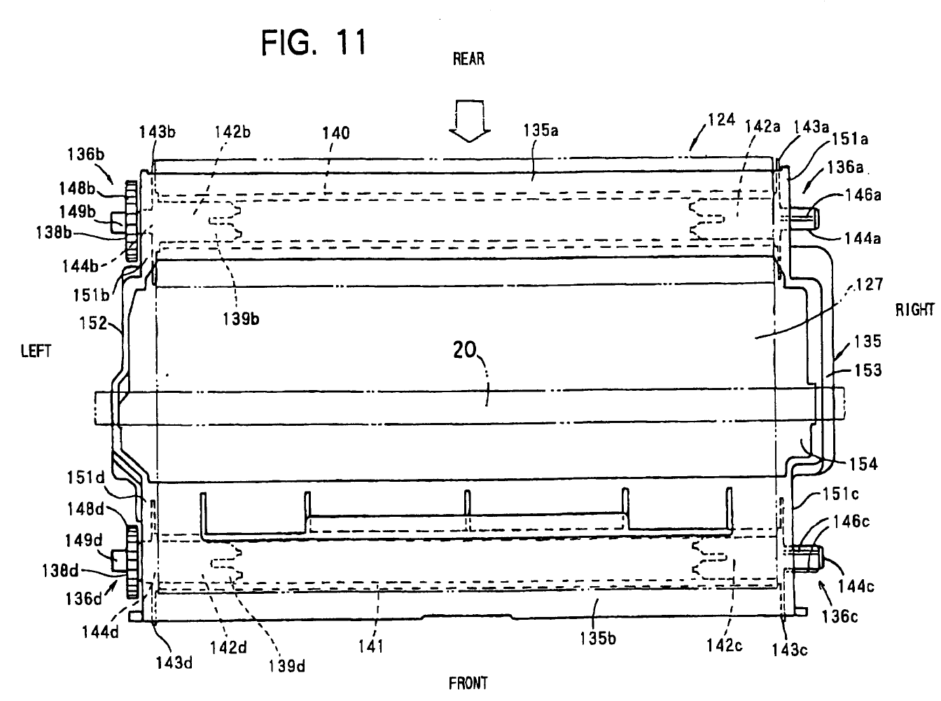

Next, an ink ribbon cartridge 124 according to a third embodiment of the present invention will be described while referring to FIGS. 11 to 18. It should be noted that the ink ribbon cartridge 127 is used in the facsimile machine 1 in the same manner as in the first embodiment described above.

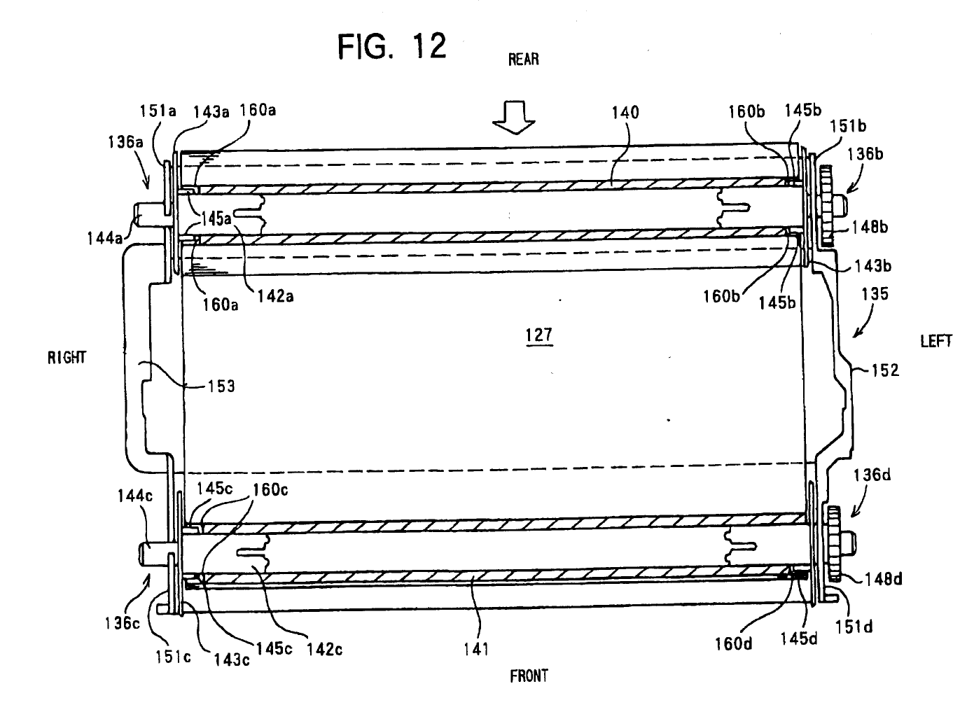

As shown in FIGS. 11 and 12, the ink ribbon cartridge 124 includes a cartridge case 135, an ink ribbon 127, a pair of right and left supply spools 136a, 136b, a pair of right and left takeup spools 136c, 136d, a cylindrical supply tube 140, and a cylindrical takeup tube 141. The supply spools 136a, 136b and the takeup spools 136c, 136d are collectively referred to as spools 136. Each of the tubes 140, 141 has right and left ends. The supply spools 136a, 136b are fitted into the right and left ends of the supply tube 140, respectively, and the takeup spools 136c, 136d are fitted into the right and left ends of the takeup tube 141, respectively. It should be noted that the supply spools 136a, 136b serve as the supply spool 25 shown in FIG. 1, and the takeup spools 136c, 136d serve as the takeup spool 26 shown in FIG. 1. Each of the spools 136 are formed by, for example, compound resin injection molding.

The ink ribbon 127 is the same as the ink ribbon 27 described in the first embodiment and is wound around the supply tube 140 and the takeup tube 141.

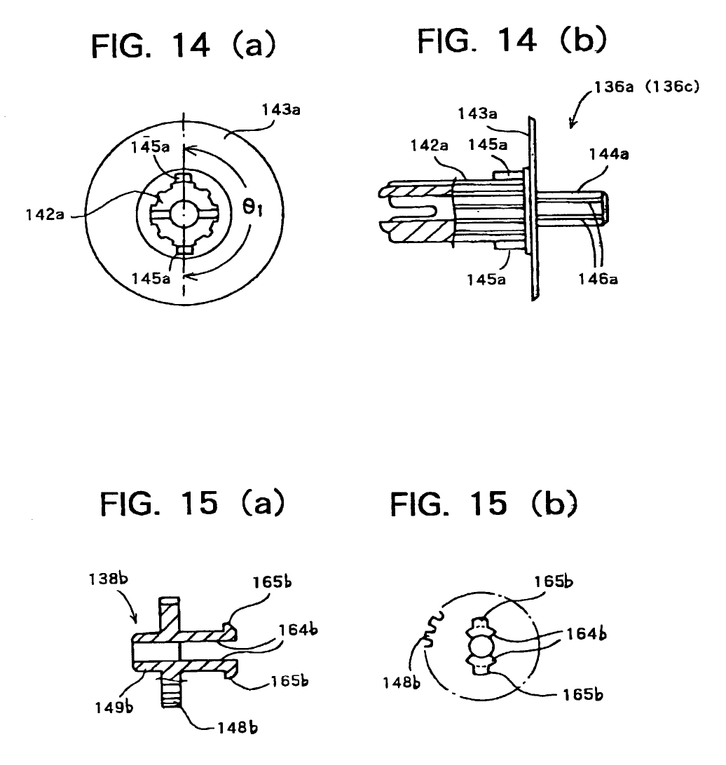

Next, the spools 136a, 136c will be described while referring to FIGS. 14(a) and 14(b). It should be noted that because the supply spool 136a and the takeup spool 136c have the same configuration and dimensions, only the supply spool 136a will be described so as to avoid duplication in explanation. As shown in FIG. 14(b), the supply spool 136a has a cylindrical inner shaft 142a, a flange 143a, and a cylindrical supporting shaft 144a. The inner shaft 142a is for fitting in the right end of the supply tube 140, and is formed with a pair of engagement protrusions 145a adjacent to the flange 143a. As shown in FIG. 14(b), the engagement protrusions 145a are arranged at an angle θ1 of 180 degrees with respect to an axial center of the supporting shaft 144a. The supporting shaft 144a is formed with a plurality of protruding ribs 146a at its outer peripheral surface. The protruding ribs 146a are separated by an appropriate distance from one another around the circumference of the supporting portion 144a.

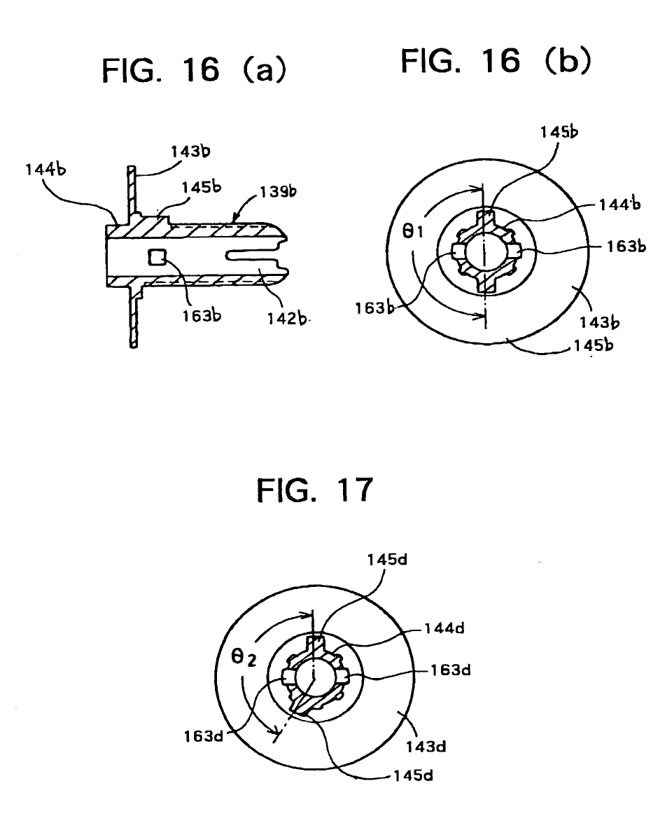

Next, the supply spool 136b will be described while referring to FIGS. 11, 12, and 15(a) to 16(b). As shown in FIG. 11, the supply spool 136b has a first portion 139b and a second portion 138b detachably engaged with the first portion 139b. As shown in FIGS. 16(a) and 16(b), the first portion 139b is formed with an inner shaft 142b, a flange 143b, and a supporting shaft 144b. As shown in FIG. 12, the inner shaft 142b is formed with a pair of engagement protrusions 145b and a pair of attachment holes 163b adjacent to the flange 143b. The engagement protrusions 145b are arranged at an angle of 180 degrees with respect to an axial center of the inner shaft 142b. The attachment holes 163b are penetrating the inner shaft 142b in its radial direction.

As shown in FIGS. 15(a) and 15(b), the second portion 138b has a gear 148b, an outer shaft 149b, and a pair of arms 165b. Each of the arms 164b is formed with an engagement portion 165b extending radially outward from the corresponding arm 164b. The engagement portions 165b are engageable in the attachment holes 163b formed in the inner shaft 142b.

According to this configuration, when the arms 164b are inserted into the support shaft 144b against the resilient force of the arms 164b, the engagement portions 165b engage in the attachment holes 163b, thereby preventing the outer shaft 144b from unintentionally separating from the inner shaft 142b.

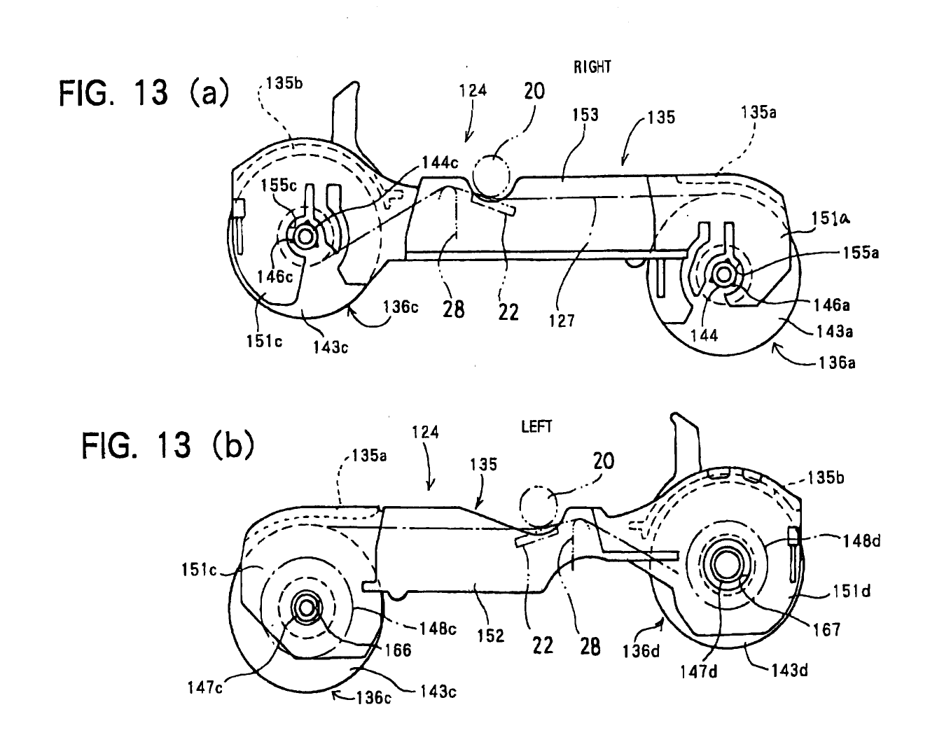

Next, the takeup spool 136d will be described. The takeup spool 136d has a configuration and dimensions similar to those of the supply spool 136b. Therefore, detailed description of the takeup spool 136d will be omitted. However, as shown in FIGS. 11 and 13(b), a supporting shaft 144d of the takeup spool 136d has a diameter greater than a diameter of the supporting shaft 144b of the supply spool 136b. Also, positions where engagement protrusions 145d in the takeup spool 136d are formed differ from that in the supply spool 136b. Specifically, as shown in FIG. 17, the engagement protrusions 145d are arranged at an angle θ2 of 120 degrees with respect to an axial center of a support shaft 144d.

Next, the supply tube 140 and the takeup tube 141 will be described. As shown in FIG. 12, the supply tube 140 is formed with a pair of grooves 160a in its right end and a pair of grooves 160c in its left end. Similarly, the takeup tube 141 is formed with a pair of grooves 160c in its right end and a pair of grooves 160d in its left end. Each pair of the grooves 160a to 160d are for engaging with the corresponding engagement protrusions 145a to 145d of the spools 136. Although not shown in the drawings, the grooves 160d at the left end of the takeup tube 141 are arranged at an angle of 120 degrees with respect to an axial center of the takeup tube 141. On the other hand, each pair of the other grooves 160a to 160c are arranged at an angle of 180 degrees with respect to an axial center of the corresponding tube 140, 141.

With this configuration, the takeup spool 136d can only be mounted in the left end of the takeup tube 141. In this way, the position where the takeup spool 136d can be attached is restricted. On the other hand, the spools 136a to 136c are arranged at the same angle θ1, and so can fit into any end of the tubes 140, 141, with the exception of the left end of the takeup tube 141.

Next, an explanation for configuration of the cartridge case 135 according to the third embodiment will be provided while referring to FIGS. 11 to 13(b). As shown in FIGS. 11 and 12, the cartridge case 135 includes a supply-side upper cover 135a, a takeup-side upper cover 135b, a pair of connection ribs 152, 153, and four side plates 151a, 151b, 151c, 151d. All of these components are formed integrally by, for example, compound resin injection molding. The supply-side upper cover 135a and the takeup-side upper cover 135b are elongated in the left and right directions. The connection rib 152 connects the left end of the supply-side upper cover 135a to the left end of the takeup-side upper cover 135b. Similarly, the connection rib 153 connects the right end of the supply-side upper cover 135a to the right end of the takeup-side upper cover 135b. As a result, the connection ribs 152, 153, the supply-side upper cover 135a, and the takeup-side upper cover 135b define a window portion 154.

The side plates 151a to 151d are disposed where the connection ribs 152, 153 connect the supply-side upper cover 135a and the takeup-side upper cover 135b. As shown in FIG. 13(a), the side plates 151a, 151c are formed with support openings 155a, 155c, respectively. Since the side plates 151a and 151c have the same configuration as the side plates 51a and 51c of the first embodiment, detailed description will be omitted.

On the other hand, as shown in FIG. 13(b), the side plates 151b, 161d are formed with circular holes 166, 167, respectively. The circular hole 167 has a diameter greater than a diameter of the circular hole 166. The circular hole 167 is capable of freely fitting the support shaft 144d of the takeup spool 136d. The circular hole 166 is capable of freely fitting the support shaft 144b of the supply spool 136b, but not the support shaft 144d of the takeup spool 136d.

Next, operations for attaching the spools 136b, 136d to the cartridge case 135 will be described. First, the support shaft 144d of the takeup spool 136d is fitted into the circular hole 167 from the inner side of the side plate 151d so as to protrude outward through the circular hole 167. Then, the arm 164d of the outer shaft 149d is inserted into the supporting shaft 144d from outside of the side plate 151d so that the side plate 151d is sandwiched between the flange 143d and the gear 148d. At this time, the engagement portions 165d at the front tip of the arm 164d engage into the attachment holes 163d of the inner shaft 142d. In this way, the takeup spool 136d is prevented from unintentionally separating from the cartridge case 135. Then, the supply spool 136b is attached to the side plate 151b in the same manner as the takeup spool 136d described above. Because, as described above, the takeup spool 136d has the large diameter support shaft 144d, the takeup spool 136d can only be mounted in the circular hole 167. Therefore, the position where the spool 136d is mounted is restricted with respect to the cartridge case 138.

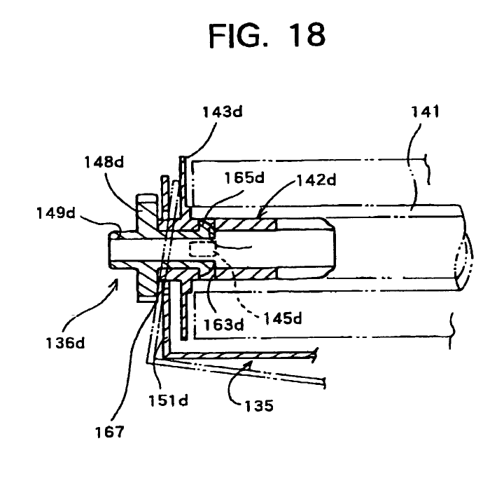

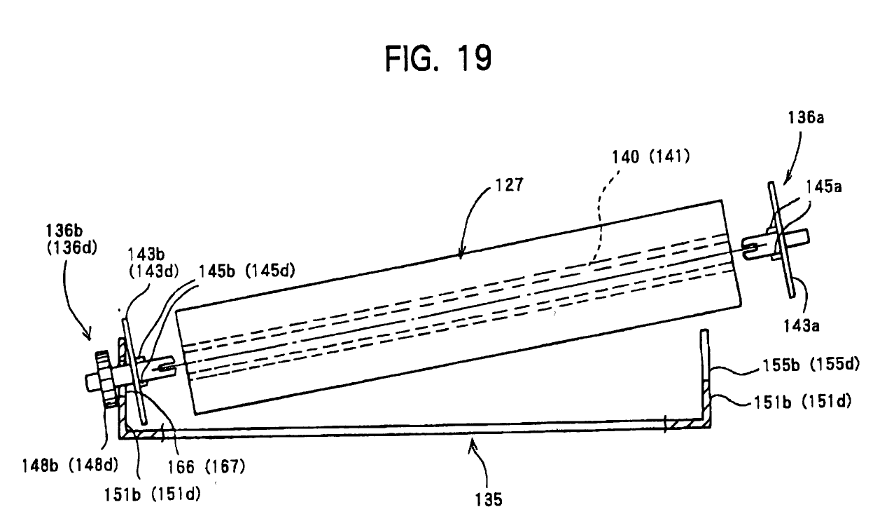

The diameter of the support shaft 144b is smaller than the diameter of the circular hole 166, and the diameter of the support shaft 144d is smaller than the diameter of the circular hole 167. Therefore, as shown in FIGS. 18 and 19, axial lines of the spools 136b, 136d can be oriented at a slant with respect to the corresponding side plate 151b, 151d. This configuration is advantageous for reasons to be described later.

Next, operations for mounting the ink ribbon 127 to the cartridge case 135 will be described. First, as shown in FIG. 10, the cartridge case 135 with the spools 136d, 136b attached thereto is turned upside down, that is, with the upper covers 135a, 135b facing downward. Then, the left ends of the supply tube 140 and the takeup tube 141 are engaged with the spools 136b, 136d, respectively. At this time, since the axial lines of the spools 136b, 136d can be oriented at a slant with respect to the corresponding side plate 151b, 151d, the supply tube 140 and the takeup tube 141 can be mounted without removing the spools 136b, 136d from the cartridge case 135, and moreover without the ink ribbon 127 bumping against the cartridge case 135. Also, since the left end of the takeup tube 141 can be engaged only with the takeup spool 136d, the ink ribbon 127 can be mounted only with a specific orientation to the cartridge case 135, that is, without mistaking the upper and lower surfaces and right and left sides of the ink ribbon 127.

Next, the spools 136a and 136c are mounted in the right sides of the supply tube 140 and the takeup tube 141. It should be noted that because the supply spool 136a and the takeup spool 136c have the same configuration, the spools 136a, 136c can be attached to the right end of either the supply tube 140 or the takeup tube 141. Afterwards, the supporting shafts 144a, 144c of the spools 136a, 136c are inserted into the corresponding support openings 155a, 155b As a result, the axial lines of the tubes 140, 141 are oriented perpendicular with respect to the side plates 151a, 151c. Also, in the same manner as in the first embodiment described above, the supporting shafts 144a, 144c protruding from the right side of the cartridge case 135 are arranged substantially concentric with the inner peripheral surface of the support openings 155a, 155c thereby preventing the protruding ribs 146a, 146c from contacting with the inner peripheral surfaces defining the support openings 155a, 155c.

When the ink ribbon cartridge 124 is dismounted from the facsimile machine 1, the protruding ribs 146a, 146c of the spool 136a, 136c prevent the spools 136a, 136c, that is, the supply tube 140 and the takeup tube 141, from rotating in the same manner in the above-described first embodiment. As a result, the ink ribbon 127 wound around the supply tube 140 and the takeup tube 141 will not loosen.

According to the third embodiment described above, the operations for exchanging the ink ribbon 127 can be performed without dismounting the spools 136b, 136d from the cartridge case 135. Therefore, it is unnecessary for an operator to test to find out the correct combination of spools 136 and side plates 151 each time operations for exchanging the ink ribbon 127 are performed. Therefore, the operations for exchanging the ink ribbon 127 can be quickly performed.

While the invention has been described in detail with reference to specific embodiments thereof, it would be apparent to those skilled in the art that various changes and modifications may be made therein without departing from the spirit of the invention, the scope of which is defined by the attached claims.

For example, the ink ribbon cartridge according to the present invention is used in a facsimile machine in the above-described embodiments. However, the ink ribbon cartridge of the present invention can be used in a printer, a copy machine, or a machine provided with a plurality of these functions.

Also, instead of or in addition to the above-described configurations, a portion or all of the side plate 51d (151d) can be colored in one color, for example, red, and a portion or all of the corresponding takeup spools 36d (136d) can be colored in the same color, that is, red, as the side plate 51d (151d). Also, portions or all of the other three spools 36a to 36c (136a to 136d) can be colored in a different color, such as green, instead of red. Moreover, the left end of the takeup body 41 (141) can be colored in the first color (red). With this configuration, the operator can mount the ink ribbon with the correct orientation, that is, with the upper side facing up and right and left side facing right and left into the cartridge case 35 (135) by arranging the same colored portions with extreme ease. In addition to this, the side plates of the cartridge case can also be colored in a different color so that the operator can recognize the right and left sides of the cartridge case 35 (135).

What is claimed is:

1. An ink ribbon cartridge frame, comprising:
a supply side upper cover having a side segment at each end;
a takeup side upper cover having a side segment at each end; and
a pair of connection ribs, a connection rib extending between a side segment on corresponding ends of each of the supply side cover and the takeup side cover, a projection extending from a lower side of each connection rib proximate to a joining of the connection rib and the side segment of the supply side cover.

2. The ink ribbon cartridge frame according to claim 1, further comprising a projection extending from each side segment of the takeup side cover, the side segment projection extending from an outer surface of the side segment and away from the takeup side cover.

3. The ink ribbon cartridge frame according to claim 2, wherein each side segment has a substantially centered opening and the side segment projection is higher than the opening on the side segment and at an opposite side of the opening than a connection of the connection rib to the side segment.

4. The ink ribbon cartridge frame according to claim 1, wherein each connection rib has a recessed area in an upper surface.

5. The ink ribbon cartridge according to claim 4, wherein the recessed areas are substantially aligned.

6. The ink ribbon cartridge according to claim 5, wherein an axis through a center of the recessed areas is perpendicular to the pair of connection ribs.

7. An ink ribbon cartridge, comprising:
a cartridge frame comprising:
a supply side upper cover having a side segment at each end;
a takeup side upper cover having a side segment at each end;
a pair of connection ribs, a connection rib extending between a side segment on corresponding ends of each of the supply side cover and the takeup side cover, a projection extending from a lower side of the connection rib proximate to a joining of the connection rib and the side segment of the supply side cover;
a spool mounted to each side segment; and
an ink sheet set supported by the spools.

8. The ink ribbon cartridge according to claim 7, wherein the ink sheet set comprises:
a supply core;
a takeup core; and
an ink sheet wound on the supply core and attached to the takeup core at an end, the ink sheet unwinding from the supply core and winding onto the takeup core in use.

9. The ink ribbon cartridge according to claim 8, further comprising a projection extending from each side segment of the takeup side cover, side segment projection extending from an outer surface of the side segment and away from the takeup side cover.

10. The ink ribbon cartridge according to claim 9, wherein each connection rib has a recessed area in an upper surface.

11. An ink ribbon cartridge frame, comprising:
a supply side upper cover having a side segment at each end;
a takeup side upper cover having a side segment at each end; and
a pair of connection ribs, a connection rib extending between a side segment on corresponding ends of each of the supply side cover and the takeup side cover, wherein a projection extends from each side segment of the takeup side cover, the side segment projection extending from an outer surface of the side segment and away from the takeup side cover.

12. The ink ribbon cartridge frame, according to claim 11, further comprising, a projection extending from a lower side of each connection rib proximate to a joining of the connection rib and the side segment of the supply side cover.

13. The ink ribbon cartridge frame according to claim 11, wherein each connection rib has a recessed area in an upper surface.

14. The ink ribbon cartridge frame according to claim 13, wherein the recessed areas are substantially aligned.

15. The ink ribbon cartridge frame according to claim 13, wherein an axis through a center of the recessed areas is perpendicular to the pair of connection ribs.

16. The ink ribbon cartridge frame according to claim 11, wherein each side segment has a substantially centered opening and the side segment projection is higher than the opening on the side segment and at an opposite side of the opening than a connection of the connection rib to the side segment.
